(19) United States
(12) Patent Application Publication
(10) Pub. No.: US 2003/0207965 A1
(43) Pub. Date: Nov. 6, 2003

(54) Coatings made with trinidad lake asphalt

(76) Inventor: Dolly Nicholas, Marabella (TT)

Correspondence Address: NIXON & VANDERHYE P.C., 8th Floor, 1100 North Glebe Road, Arlington, VA, 22201-4714, US

(21) Appl. No.: 09/935,663

(22) Filed: Aug. 24, 2001

Related U.S. Application Data
(62) Division of application No. 09/485,070, filed on Sep. 13, 2000, now abandoned.
Application No. 09/485,070 is a 371 of international application No. PCT/IB98/01196, filed on Aug. 4, 1998.
(60) Provisional application No. 60/064,099, filed on Nov. 3, 1997.
(60) Provisional application No. 60/055,097, filed on Aug. 6, 1997.

(51) Int. Cl. C08K 5/01

(52) U.S. Cl. 524/62

(57) ABSTRACT

A method of making a coating, including: mixing clay and a carrier to define a first mixture; heating Trinidad Lake Asphalt; reacting the Trinidad Lake Asphalt with the first mixture to define a second mixture; and reacting the second mixture with a polymer/co-polymer dissolved in a carrier to produce a coating material.

### RELATED APPLICATIONS

The instant application hereby claims the benefit of the filing date of U.S. Provisional Application Serial No. 60/055,097 filed Aug. 6, 1997, and U.S. Provisional Application Serial No. 60/064,099 filed Nov. 3, 1997.

### BACKGROUND OF THE INVENTION

The present invention relates generally to the field of coatings, and, more particularly, to improved coatings which incorporate Trinidad Lake Asphalt as a raw material therein.

Coatings, such as paints, primers, sealers, epoxies, roofing compounds, sound deadeners, road markings, membranes, and the like, have for many years been manufactured using a variety of base materials as well as in combination with other specific materials. Some of these base materials or base materials including other materials have not been environmentally friendly. For example, epoxies, which have stood the test of time and have proven to be useful for many applications, are generally coal tar based or plastic based, with the coal tar based epoxies being widely accepted as carcinogenic.

Due to environmental concerns, manufacturers of such coatings are now attempting to use raw materials, which would give the same performance and, in addition, would be more environmentally friendly. However, to date, there has been no suitable substitutes for these raw materials which have been considered to provide satisfactory coating products. Thus, many environmentally unfriendly coating products are still being widely used.

Thus, a need exists for improved coating products which overcome the disadvantages of the prior art.

### SUMMARY OF THE INVENTION

It is therefore a primary object of the present invention to provide improved coating products, including, but not limited to, paints, primers, sealers, epoxies, roofing compounds, sound deadeners, road markings, membranes and any other suitable coating products.

A further object of the present invention is to provide improved coating products which have at least as good or better performance characteristics as prior art coatings and, in addition, are more environmentally friendly.

Another object of the instant invention is to provide improved coating products which advantageously use Trinidad Lake Asphalt, also known as Trinidad Natural Asphalt or Epure, as a raw material in said coating products.

Yet another object of the instant invention is to provide improved coatings which are resistant to, among other things, petroleum distillates, aromatic solvents, salt water immersion, an electric current, acids and alkalis.

A further object of the invention is to provide improved coatings which are unaffected by, among other things, exposure to fresh water, deionized water systems, distilled water systems, bromides, chlorides and sulphate.

A further object of the instant invention is to provide coatings having improved durability, flexibility, resistance to abrasion, resistance to an applied force, resistance to aromatic solvents and/or enhanced aesthetics.

Yet another object of the instant invention is to provide improved coatings which can be used in low altitude and low temperature environments without degradation.

A more specific object of the instant invention is to provide an improved epoxy product, an improved sealant product, such as a seam sealant, an improved roofing compound product, and improved undercoating/sound deadener product, and improved water tank paint, an improved chassis black product, and improved zinc primer black product, an improved zinc primer grey product, an improved road marking coating product, an improved coating which has a dry film thickness of 2 mil. or greater which is also termed a membrane, as well as other types of improved coating products, all of which advantageously incorporate Trinidad Lake Asphalt as a raw material therein.

Yet another object of the instant invention is to make coatings using non-molten mixers (e.g. Banbury, high shear internal mixers, etc.) instead of molten mixers (heaters, etc.) for the purpose of mixing the Trinidad Lake Asphalt and at least one other raw material.

These and other objects and advantages are achieved by the present invention, which provides improved coating products, all of which include at least some Trinidad Lake Asphalt therein as well as at least one other raw/modifying material.

Other features, objects and advantages of the subject invention will become apparent from a study of the following specification which describes preferred applications and embodiments of the instant invention and is not to be interpreted as limiting the scope of the instant invention beyond the true scope of the appended claims herein.

### DETAILED DESCRIPTION OF THE PREFERRED EMBODIMENTS

Trinidad Lake Asphalt (hereafter “TLA”), also known as Trinidad Natural Asphalt or Epure, is a naturally occurring Lake Asphalt which is found in the island of Trinidad in the West Indies. This natural phenomenon, TLA, is different from and is not to be confused with tar sands, or tar pits or even asphalt which is a natural or mechanical mixture in which bitumen is associated with mineral matter. An accepted definition which has been given to TLA is: an asphalt which, as found in nature, is in a condition of flow or fluidity.

As dug from the earth, TLA contains thirty percent (30%) water which is normally be removed through refining under conditions of temperature. The molten material is then filtered and sometimes packed into silicone treated hardboard drums. The drums are typically silicone treated as the temperature at which the molten TLA is filled into the drum is generally around 163° C.

Prior to the instant invention, TLA has been used only in paving or road building materials and applications. In accordance with the instant invention, it has now been discovered that TLA can be used as a component of many different types of coatings to improve the characteristics and/or performance thereof, with new and unexpected results.

More particularly, the instant inventor has discovered that TLA can advantageously be used as a raw material to make a variety of coating products in order to provide an environmentally friendly product with improved characteristics. As used herein, the term coatings is meant to have a broad meaning and to include, but not be limited to, paints, primers, sealers, epoxies, roofing compounds, underbody coating/sound deadener, road markings, membranes, and any other similar or suitable coatings whether expressly referenced herein or not.

In its broadest sense, the instant invention is directed to the use of TLA as a raw material in the manufacture of any coating. More particularly, the invention involves coatings made by combining TLA and at least one other known type of raw material, such as solid carriers (e.g., carbon fibers, etc.), and/or liquid carriers (e.g. water, alcohol, etc.) and/or gaseous carriers (polar gases, non-polar gases, etc.), and/or anything which modifies TLA from its natural state.

In accordance with a preferred embodiment of the instant invention, many coatings can be made using some or all of the following elements in the range (percent by weight) indicated below, in conjunction with the TLA:

| | |
|---|---|
| TLA | 1% to 99% |
| Polymers/Co-Polymers | 1% to 99% |
| Carrier | 1% to 99% |
| Clay | 1% to 95% |
| Pigment | 1% to 95% |
| Carbonaceous material | 1% to 95% |
| Resins | 1% to 99% |

The carrier may be any suitable solid and/or liquid and/or gaseous material. For example, as described in further detail below, the carrier, could be a petroleum distillate, such as White Spirit and/or Methylated Spirit and/or water. The carbonaceous material may be, for example, fibre (natural or synthetic), carbon black (both for reinforcing and colorant) or charcoal (activated or non-activated). The clay may be, for example, a material known as Claytone 40 and/or silica. The resin may be, for example, a polyamide, such as the product known as Epon 813 Resin, and/or a epichlonolydrin/bisphenol A, such as the product known as Versamid 115 Resin and/or water. The polymers/co-polymers may be, for example, rubber.

More specific examples of particular coating products made in accordance with the instant invention will now be described in detail below, along with general information on the preferred uses for such products, the characteristics thereof and exemplary processes for making such products. It is to be understood, however, that the examples below are considered to be preferred embodiments of the invention and that various changes and/or modifications could be made thereto, as one skilled in the art will understand, without deviating from the scope of the instant invention.

Epoxy Product Example

The following is an example of a two part epoxy system made in accordance with one embodiment of the instant invention. A variety of improved epoxy products can be made using the following elements in the ranges (percent by weight) set forth below:

| | |
|---|---|
| TLA | 1% to 60% |
| Polymers/Co-Polymers | 1% to 60% |
| Carrier | 1% to 60% |
| Clay | 1% to 60% |
| Resins | 1% to 80% |

In accordance with a more particular embodiment, the raw materials and percent by weight thereof in the epoxy product may be as follows:

| | |
|---|---|
| TLA | 19.79 |
| White Spirit | 11.61 |
| Claytone 40 | 1.85 |
| Methylated Spirit | 0.53 |
| Toluene | 4.75 |
| Rubber | 0.26 |
| Silica | 6.07 |
| Epon 813 Resin | 27.44 |
| Versamid 115 Resin | 27.70 |

It is noted that in this embodiment, all of the elements, except Epon 813 Resin form the first part of the two part epoxy system. The Epon 813 Resin is used as the second part of the epoxy system.

A preferred process for making this epoxy is as follows:

1) Claytone 40 is stirred with White Spirit to form a slurry and poured into a blending tank;

2) TLA is crushed in a pulveriser into sizes of 1″-2″. It is then weighed and fed into the heating tank. This is heated to 140 degrees C.-150 degrees C. In the molten state this is poured into the blending tank and blended for 10 minutes;

3) The rubber which was pre-weighed and dissolved by stirring with 50% of the toluene is then added at this stage. Blend for approximately 20 minutes; reaction/bonding must occur;

4) Silica is added at this stage;

5) The methylated spirit is poured into the blending tank to complete blending;

6) The product is then fed through the vibratory screen of sizes 25 mesh and 80 mesh;

7) The filtered product is cooled to 30° C.-35° C. Versamid 115-resin is blended in to give a uniform consistency and re-filtered through the 25 mesh and 80 mesh filters;

8) The blending tank is jacketed to allow a cooling solution to flow through during the blending process; The temperature of finished product: 50° C-60° C.

9) The Epon 813 Resin is then used as the second part of the epoxy system;

The epoxy described herein, provides a colorless or colored, rubberized or non-rubberized, two part epoxy system. The complete TLA may be used which means that no black has to be removed from the material in order for it to be pigmented to any color or for it to remain colorless. Further, the amount of Pigment required is less than twenty percent (20%) of the complete formulation. This epoxy can be made into all relevant colors and may also remain colorless. All the inherent properties which are present in the solvent “based” epoxies inclusive of drying times, are retained.

Additional information, in the form of a data sheet, regarding characteristics and usage of this exemplary epoxy product are set forth below.

This amide cured two part epoxy dries to an extremely hard finish of differing flexibilities and can be used in harsh environments. It contains no coal tar, is non-carcinogenic, and is environmentally sound. It is natural asphalt based and the coating provides maximum protection to metal surfaces, and has outstanding low moisture-vapor transmission. It also contains no heavy metals, e.g., mercury, lead or vanadium, but does contain a high percentage of titanium.

| | |
|---|---|
| PETROLEUM PRODUCTS | Resistant to sour crudes and |
| | lubricating oils. |
| ALKALI RESISTANCE | Very resistant to mild alkalis and |
| | can be used as a tank lining for |
| | aggressive solutions such as 20% |
| | caustic, 10% calcium hydroxide, |
| | 10% ammonia and 10% potassium |
| | hydroxide. |
| ACID RESISTANCE | Unaffected by most common acids, |
| | e.g., 15% hydrochloric acid, 25% |
| | sulfuric acid and 20% nitric acid. |
| SEA WATER | Unaffected by complete sea |
| | immersion and sea blast. Also, |
| | unaffected by fresh water, |
| | deionized/distilled water systems, |
| | bromides, chlorides, sulfates, etc. |
| PRIMING | Usual epoxy primers |
| SURFACE PREPARATION | Sand blasting, white metal blasting |
| | where metal has been previously |
| | coated or severe corrosion has |
| | occurred, or as specified by The |
| | Society for Protective Coatings. |
| SHELF LIFE | Indefinite, once properly covered. |
| DENSITY OF FINISHED | 9.17 lb./gal. |
| PRODUCT | |
| FLASH POINT | Above 140° F. |
| V.O.C. | 20% |
| BINDER CONTENT | 80% |
| SOLVENT | 20% |
| SOLIDS CONTENTS | 80% |
| FINISH | Gloss |
| COLOR | Black |
| COVERAGE | 88 sq. ft./gal at 8 mil. Dry Film |
| | Thickness |
| DRYING TIME | 6-8 HOURS |
| MIXING RATIO | 1:1 BASE TO CATALYST AS |
| | SUPPLIED |
| NUMBER OF COATS | Two 4 mil. coats |
| APPLICATION | Brush, spray and roll-on. |
| POT LIFE | 3 hours at ambient temperature |
| SALT SPRAY | No deterioration of panels |
| CLEAN UP | Vinegar, immediately after use |
| TEMPERATURE RESISTANCE | 212° F. (panel immersed in boiling |
| | water) |

Sealant Coating Example

The following is an example of a sealant product made in accordance with one embodiment of the instant invention. A variety of improved sealant products can be made using the following elements in the approximate ranges (percent by weight) set forth below:

| | |
|---|---|
| TLA | 1% to 99% |
| Polymers/Co-Polymers | 1% to 60% |
| Carrier | 1% to 60% |
| Clay | 1% to 60% |

In accordance with a more particular embodiment, the raw materials and percent by weight thereof in the sealant product may be as follows:

Percentage by weight of raw materials

| | |
|---|---|
| TLA | 75.52 |
| White Spirit | 12.86 |
| Claytone 40 | 2.70 |
| Methylated Spirit | 0.83 |
| Toluene | 7.26 |
| Rubber | 0.83 |

A preferred process for making this product is as follows:

1. Claytone 40 is stirred with the white spirit to form a slurry and poured into a blending tank.

2. TLA is crushed in a pulveriser into sizes of 1″-2″. It is then weighed and fed into the heating tank. This is heated to 140 degree C.-150 degree C. In ihe molten state this is poured into the blending tank and blended for 10 minutes.

3. The rubber which was pre-weighed and dissolved by stirring with the toluene is then added at this stage. Blend for approximately 20 minutes. Reaction/bonding must occur.

4. Finally the methylated spirit is poured into the tank and blending is completed with a uniform consistency.

5. The product is then fed through a vibratory screener of sizes 25 mesh and 80 mesh for a finished product. Blending tank is jacketed to allow a cooling solution to flow through during the blending process. Temperature of finished product: 50° C.-60° C.

Additional information, in the form of a data sheet, regarding characteristics and usage of this exemplary sealant product are set forth below:

| | |
|---|---|
| GENERIC TYPE | Non-sag rubberized natural asphalt |
| | sealant |
| RECOMMENDED USES | Sealing leaks of drinking water |
| | tanks, (metal and concrete) |
| | cementing down asphalt shingles, |
| | repairing cracks in concrete walls or |
| | in old roofs. Can also be used for |
| | sealing internal joints and seams in |
| | vehicular bodies. If it is to be used |
| | extensively on a roof then it is |
| | recommended that the area be |
| | covered with Surecoat's Roofing |
| | Compound Grey. Use extensively in |
| | built-up roofing systems. |
| GENERAL PROPERTIES | A black natural asphalt cement |
| | containing a special rubber blend. It |
| | will adhere to any dry surface. |
| CHEMICAL RESISTANCE | Resistant to splashes from all |
| | petroleum solvents e.g., gasoline, |
| | diesel fuel, etc. Just allow area to |
| | dry and film is back to normal. DO |
| | NOT wipe area. |
| TEMPERATURE | Can be stoved up to 150° C. for 30 mins. |
| SURFACE PREPARATION | Surface must be dry |
| PRIMING | Concrete surfaces must first be |
| | sealed off using, for example, |
| | Surecoat's Concrete Sealant. |
| THINNING & CLEAN-UP | Surecoat #AP3 Reducer |
| TOP COAT REQUIRED | Not necessary |
| APPLICATION | Brush, spray or roll-on |

SPECIFICATIONS

| | |
|---|---|
| SOLIDS CONTENT | 85-90% |
| DRY FILM THICKNESS | 400 um (per coat) |
| COVERAGE | 4 sq. meter/liter (100 sq. ft./US gal); |
| | might be more or less depending on |
| | use e.g., size of cracks, etc. |
| SHELF LIFE | Indefinite |
| COLOR | Black |
| APPLICATION | Ambient |
| TEMPERATURE | |
| DRYING TIME | Touch dry 1-2 hours. Complete |
| | drying 24-36 hours. Can be painted |
| | over after 24 hours |
| VISCOSITY | 320-330 (25 C Penetration Cone) |
| FLASH POINT | 37° C. |
| WEIGHT PER US GALLON | 3.80 kg (8.37 lb.) |

Roofing Compound Example

The following is an example of a roofing compound product made in accordance with one embodiment of the instant invention. A variety of improved roofing compound products can be made using the following elements in the approximate ranges (percent by weight) set forth below:

| | |
|---|---|
| TLA | 1% to 90% |
| Polymers/Co-Polymers | 1% to 60% |
| Carrier | 1% to 60% |
| Clay | 1% to 60% |
| Pigment | 1% to 80% |

In accordance with a more particular embodiment, the raw materials and percent by weight thereof in the roofing compound product may be as follows:

Percentage by weight of raw materials

| | |
|---|---|
| Trinidad Natural Asphalt | 43.88 |
| White Spirit | 24.70 |
| Claytone 40 | 3.84 |
| Methylated Spirit | 1.20 |
| Toluene | 11.51 |
| Rubber | 0.72 |
| Titanium Dioxide Pigment | 14.15 |

A preferred process for making this product is as follows:

1. Claytone 40 is stirred with 40% of the white spirit to form a slurry and poured into a blending tank.

2. Asphalt is crushed in a pulveriser into sizes of 1″-2″. It is then weighed and fed into the heating tank. This is heated to 140 degrees C.-150 degrees C. In the molten state this is poured into the blending tank and blended for approximately 10 minutes.

3. Remaining toluene and white spirit solvents are pumped into the blending tank at this stage.

4. The rubber which was pre-weighed and dissolved by stirring with 50% of the toluene is then added at this stage. Blend for approximately 20 minutes. Reaction/bonding must occur.

5. Titanium dioxide pigment is then added at this stage.

6. Finally the methylated spirit is poured into the blending tank to give a uniform consistency.

7. The product is then fed through the vibratory screen of sizes 25 mesh and 80 mesh for a finished product.

8. The blending tank is jacketed to allow a cooling solution to flow through during the blending process. Temperature of finished product: 50° C.-60° C.

Additional information, in the form of a data sheet, regarding characteristics and usage of this exemplary roofing compound product are set forth below:

| SURFACE PREPARATION | For new galvanize: | |
|---|---|---|
| | 1) | Degrease |
| | 2) | Apply each primer and leave |
| | | for 1-2 hours |
| | 3) | Use Surecoat Zinc Chromate |
| | | Primer and then Roofing |
| | | Compound |
| | For old galvanize: | |
| | 1) | Remove all rust with a wire |
| | | brush and follow (2) and (3) |
| | | above. |

| | |
|---|---|
| COMPONENT | One pack |
| COVERAGE | 15 sq. meter/US gallon |
| APPLICATION | Brush, spray or roll-on |
| DRY FILM THICKNESS | 130-140 microns |

SPECIFICATIONS

| | |
|---|---|
| SOLIDS CONTENT | 68-70% |
| SPECIFIC GRAVITY | 1.14 |
| DRYING TIME | 1 hour |
| FLASH POINT | 37° C. |
| APPLICATION | Brush or spray |
| COLOR | Bone grey |
| RECOMMENDED USES | All types of metallic and bituminous |
| | based roofs (e.g., shingles) |
| THINNING & CLEAN-UP | Surecoat #AP4 Reducer |

Underbody Coating/Sound Deadener Example

The following is an example of a underbody coating/sound deadener product made in accordance with one embodiment of the instant invention. A variety of improved underbody coating/sound deadener products can be made using the following elements in the approximate ranges (percent by weight) set forth below:

| | |
|---|---|
| TLA | 1% to 90% |
| Polymers/Co-Polymers | 1% to 60% |
| Carrier | 1% to 60% |
| Clay | 1% to 60% |

In accordance with a more particular embodiment, the raw materials and percent by weight thereof in the underbody coating/sound deadener product may be as follows:

Percentage by Weight of Raw Materials:

| | |
|---|---|
| Trinidad Natural Asphalt | 58.63 |
| White Spirit | 13.65 |
| Claytone 40 | 1.41 |
| Methylated Spirit | 0.40 |
| Toluene | 7.63 |
| Rubber | 0.60 |
| Silica Flour | 17.67 |

A preferred process for making this product is as follows:

1. Claytone 40 is stirred with 40% of the white spirit to form a slurry and poured into blending tank.

2. Asphalt is crushed in a pulveriser into sizes of 1″-2″. It is then weighed and fed into the heating tank. This is heated to 140 degree C.-150 degree C. In the molten state this is poured into the blending tank and blended for 10 minutes.

3. Remaining toluene and white spirit solvents are pumped into the blending tank at this stage.

4. The rubber which was pre-weighed and dissolved by stirring with 50% of the toluene is then added at this stage. Blend for 20 minutes. Reaction/bonding must occur.

5. Silica is then added at this stage.

6. Finally the methylated spirit is poured into the blending tank to give a uniform consistency.

7. The product is then fed through the vibratory screen of sizes 25 mesh and 80 mesh for a finished product

8. The blending tank is jacketed to allow a cooling solution to flow through during the blending process. Temperature of finished product: 50° C.-60° C.

Additional information, in the form of a data sheet, regarding characteristics and usage of this exemplary underbody coating/sound deadener product are set forth below:

| | |
|---|---|
| GENERIC TYPE | Rubberized Natural Asphalt base |
| RECOMMENDED USES | Undercoating of all vehicles |
| GENERAL PROPERTIES | A blend of natural asphalt and |
| | fillers, etc. designed to give superb |
| | anti-corrosive and sound deadening |
| | properties. Both wet and dry films |
| | show no sagging. |
| CHEMICAL RESISTANCE | Resistant to splashes of all petroleum |
| | solvents, e.g., gasoline, diesel fuel |
| | etc. Do not wipe area. Just allow |
| | area to dry naturally. No lifting of |
| | film occurs. |
| TEMPERATURE | Can be stoved up to 150° C. for |
| | 30 mins. |

LIMITATIONS

| | |
|---|---|
| SURFACE PREPARATION | Ensure area is dry, free from dust |
| | and grease. |
| PRIMING | Not necessary |
| THINNING & CLEAN-UP | Surecoat Thinner #AP2 Reducer |
| TOP COAT REQUIRED | Not necessary |
| OVERCOATING & | N.C. Lacquer; Synthetic Resin, Non- |
| | Sand, |
| UNDERCOATING | H. Dur Rapid Extra Filler, Red Zinc |
| | Chromate Metal, Universal Metal, |
| | Yellow Zinc Chromate Metal |
| APPLICATION | Remove rust, scale, oil and grease |
| | from surface to be coated. Ensure |
| | area is dry. |
| PERFORMANCE | Stoving - can be stoved or air dried |
| | to a hard yet flexible film. Stoving |
| | can be up to 150° C. (or lower) for |
| | 30 minutes |
| HUMIDITY TEST | On bare steel for 14 weeks at 49° C. |
| | complete immersion in water. No |
| | deterioration of panel. Before and |
| | after immersion, the Carrie and |
| | Erichsen tests were performed on the |
| | panels. The Carrie test is related to |
| | the adhesive properties of the |
| | undercoating onto steel panel, whilst |
| | the Erichsen test is related both to |
| | the adhesion and elasticity of the |
| | undercoating. This product passes |
| | both tests. |

SPECIFICATIONS

| | |
|---|---|
| SOLIDS CONTENT | 80-82% |
| DRY FILM THICKNESS | 320 um (per coat) |
| COVERAGE | 43 m² (163 sq. ft./US gal) |
| SHELF LIFE | Indefinite, once properly closed |
| COLOR | Black |
| APPLICATION TEMPERATURE | Ambient |
| DRYING TIME | Touch dry 1-2 hours. Allow 24 |
| | hours before painting coating. |
| VISCOSITY | 370-380 (penetration, grease cone |
| | 25° C.) |
| FLASH POINT | 37° C. |
| WEIGHT PER US GALLON | 4.54 kg (10 lb.) |
| CORROSION TEST | Salt spray. ASTM B117. No |
| | corrosion. |

Water Tank Paint Example

The following is an example of a water tank paint product made in accordance with one embodiment of the instant invention. A variety of improved water tank paint products can be made using the following elements in the approximate ranges (percent by weight) set forth below:

| | |
|---|---|
| TLA | 1% to 85% |
| Polymers/Co-Polymers | 1% to 60% |
| Carrier | 1% to 60% |
| Clay | 1% to 60% |

In accordance with a more particular embodiment, the raw materials and percent by weight thereof in the water tank paint product may be as follows:

Percentage by Weight of Raw Materials:

| | |
|---|---|
| Trinidad Natural Asphalt | 47.00 |
| White Spirit | 21.67 |
| Claytone 40 | 1.72 |
| Methylated Spirit | 0.43 |
| Toluene | 14.59 |
| Rubber | 0.43 |
| Silica Flour | 14.16 |

A preferred process for making this product is as follows:

1. Claytone 40 is stirred with 40% of the white spirit to form a slurry and poured into blending tank.

2. Asphalt is crushed in a pulveriser into sizes of 1″-2″. It is then weighed and fed into the heating tank. This is heated to 140 degree C.-150 degree C. In the molten state his is poured into the blending tank and blended for 10 minutes.

3. Remaining toluene and white spirit solvents are pumped into the blending tank at this stage.

4. The rubber which was pre-weighed and dissolved by stirring with 50% of the toluene is then added at this stage. Blend for 20 minutes, reaction bonding must occur.

5. Silica is then added at this stage.

6. Finally the methylated spirit is poured into the blending tank to give a uniform consistency.

7. The product is then fed through the vibratory screen of sizes 25 mesh and 80 mesh for a finished product.

8. The blending tank is jacketed to allow a cooling solution to flow through during the blending process. Temperature of finished product: 50° C.-60° C.

Additional information, in the form of a data sheet, regarding characteristics and usage of this exemplary water tank paint product are set forth below. This product provides a non-toxic coating for the internal surface of drinking water tanks. It is a natural asphalt-based rubberized product in an organic solvent.

| | |
|---|---|
| COMPONENT | Single pack |
| SURFACE PREPARATION | Make sure that surface is dry and |
| | free of grease and dust. |
| APPLICATION | Brush, spray or roll-on |
| COLOR | Black |
| SOLIDS CONTENT | 65-70% |
| SPECIFIC GRAVITY | 1.03-1.10 |
| FLASH POINT | 37° C. |
| DRY FILM THICKNESS | 40-50 microns |
| SHELF LIFE | Unlimited. Replace lid when not in |
| | use. |
| DRYING TIME | Touch dry 1 hour. Overcoat 8-12 |
| | hours |
| COLOR | Black |
| COVERAGE | 8 sq. meter per liter |
| RECOMMENDED USES | Any potable water system |
| THINNING & CLEAN-UP | Surecoat #AP2 Reducer |

Chassis Black Product Example

The following is an example of a chassis black product made in accordance with one embodiment of the instant invention. A variety of improved water chassis black products can be made using the following elements in the approximate ranges (percent by weight) set forth below:

| | |
|---|---|
| TLA | 1% to 80% |
| Polymers/Co-Polymers | 1% to 80% |
| Carrier | 1% to 50% |
| Clay | 1% to 40% |

In accordance with a more particular embodiment, the raw materials and percent by weight thereof in the chassis black paint product may be as follows:

Percentage by Weight of Raw Materials:

| | |
|---|---|
| TLA | 48.00 |
| White Spirit | 21.67 |
| Claytone 40 | 1.72 |
| Methylated Spirit | 0.43 |
| Toluene | 14.59 |
| Rubber | 0.43 |
| Silica Flour | 13.16 |

A preferred process for making this product is as follows:

1. Claytone 40 is stirred with 40% of the white spirit to form a slurry and poured into blending tank.

2. Asphalt is crushed in a pulveriser into sizes of 1″-2″. It is then weighed and fed into the heating tank. This is heated to 140 degree C.-150 degree C. In the molten state this is poured into the blending tank and blended for 10 minutes.

3. Remaining toluene and white spirit solvents are pumped into the blending tank at this stage.

4. The rubber which was pre-weighed and dissolved by stirring with 50% of the toluene is then added at this stage. Blend for 20 minutes, reaction bonding must occur.

5. Silica is then added at this stage.

6. Finally the methylated spirit is poured into the blending tank to give a uniform consistency.

7. The product is then fed through the vibratory screen of sizes 25 mesh and 80 mesh for a finished product.

8. The blending tank is jacketed to allow a cooling solution to flow through during the blending process. Temperature of finished product: 50° C.-60° C.

Additional information, in the form of a data sheet, regarding characteristics and usage of this exemplary chassis black product are set forth below. The product provides a non-emulsion natural asphalt-based, rubberized coating designed to give a low sheen finish. It contains very fine fillers so as to obtain maximum protection. The coating dries to a hard finish.

| | |
|---|---|
| SURFACE PREPARATION | For previously painted surfaces - |
| | remove all loose, flaking and peeling |
| | paint with the use of a metal scraper |
| | or wire brush. Also remove all |
| | grease oil and other debris from |
| | surface. Wipe area dry and apply |
| | coating. Prime with Surecoat's Zinc |
| | Chromate Black if necessary. |
| COMPONENT | Single pack |
| APPLICATION | Brush, spray or roll-on |
| COLOR | Black |
| SHELF LIFE | Indefinite, once properly closed |
| DRYING TIME | Touch dry 10-15 mins. Recoat - 60 mins. |
| FLASH POINT | 37° C. |
| COVERAGE | 7.10 sq meter per liter |
| DRY FILM THICKNESS | 90-95 microns |
| SOLIDS CONTENT | 66-68% |
| SPECIFIC GRAVITY | 1.12-1.14 |
| RECOMMENDED USES | For chassis, under carriages, trailers, |
| | engine body and running boards |
| THINNING & CLEAN UP | Surecoat #AP2 Reducer |

Zinc Chromate Primer Black Product Example

The following is an example of a zinc chromate primer black product made in accordance with one embodiment of the instant invention. A variety of improved zinc chromate primer black products can be made using the following elements in the approximate ranges (percent by weight) set forth below:

| | |
|---|---|
| TLA | 1% to 90% |
| Polymers/Co-Polymers | 1% to 60% |
| Carrier | 1% to 60% |
| Clay | 1% to 60% |
| Pigment | 1% to 80% |

In accordance with a more particular embodiment, the raw materials and percent by weight thereof in the zinc chromate primer black product may be as follows:

Percentage by Weight of Raw Materials:

| | |
|---|---|
| Trinidad Natural Asphalt | 43.64 |
| White Spirit | 26.31 |
| Claytone 40 | 1.54 |
| Methylated Spirit | 0.44 |
| Toluene | 12.28 |
| Rubber | 0.44 |
| Silica Flour | 13.16 |
| Zinc Chromate Pigment | 2.19 |

A preferred process for making this product is as follows:

1. Claytone 40 is stirred with 40% of the white spirit to form a slurry and poured into blending tank.

2. Asphalt is crushed in a pulveriser into sizes of 1″-2″. It is then weighed and fed into the heating tank. This is heated to 140 degree C.-150 degree C. In the molten state this is poured into the blending tank and blend for 10 minutes.

3. Remaining toluene and white spirit solvents are pumped into the blending tank at this stage.

4. The rubber which was pre-weighed and dissolved by stirring with 50% of the toluene is then added at this stage. Blend for 20 minutes, reaction bonding must occur.

5. Silica flour and zinc chromate pigment are then added at this stage.

6. Finally the methylated spirit is poured into the blending tank to give a uniform consistency.

7. The product is then fed through the vibratory screen of sizes 25 mesh and 80 mesh for a finished product.

8. The blending tank is jacketed to allow a cooling solution to flow through during the blending process. Temperature of finished product: 50° C.-60° C.

Additional information, in the form of a data sheet, regarding characteristics and usage of this exemplary zinc chromate primer black product are set forth below.

This product provides a rubberized natural asphalt coating to which has been added a rust inhibitor.

| | |
|---|---|
| PRODUCT | 1) Excellent water resistance |
| CHARACTERISTICS | 2) Fast drying |
| | 3) Excellent anti-corrosive properties |
| COMPONENT | One pack |
| SURFACE PREPARATION | For normal conditions, hand or |
| | power tool cleaning is necessary. |
| | Surfaces should be free of grease, oil |
| | and debris. For severe conditions of |
| | exposure, sand blasting to S.S.P.C.6 |
| | is recommended. |
| COVERAGE | 6 sq. meter/per liter |
| DRY FILM THICKNESS | 80-85 microns |
| SOLIDS CONTENT | 64-68% |
| SPECIFIC GRAVITY | 1.13 |
| DRYING TIME | 30-45 mins. to touch. Recoat 18-24 |
| | hours |
| FLASH POINT | 37° C. |
| APPLICATION | Brush, spray or roll-on |
| COLOR | Black |
| SHELF LIFE | Indefinite once properly closed |
| RECOMMENDED USES | On all metal surfaces, where priming |
| | is necessary. |
| THINNING & CLEAN-UP | Surecoat #AP4 Reducer |

Zinc Chromate Primer Grey Product Example

The following is an example of a zinc chromate primer grey product made in accordance with one embodiment of the instant invention. A variety of improved zinc chromate primer grey products can be made using the following elements in the approximate ranges (percent by weight) set forth below:

| | |
|---|---|
| TLA | 1% to 85% |
| Polymers/Co-Polymers | 1% to 60% |
| Carrier | 1% to 60% |
| Clay | 1% to 60% |
| Pigment | 1% to 80% |

In accordance with a more particular embodiment, the raw materials and percent by weight thereof in the zinc chromate primer grey product may be as follows:

Percentage by Weight of Raw Materials:

| | |
|---|---|
| Trinidad Natural Asphalt | 32.41 |
| White Spirit | 37.50 |
| Claytone 40 | 2.08 |
| Methylated Spirit | 0.46 |
| Toluene | 15.05 |
| Rubber | 0.46 |
| Zinc Chromate Pigment | 1.62 |
| Titanium Dioxide Pigment | 10.42 |

A preferred process for making this product is as follows:

1. Claytone 40 is stirred with 40% of the white spirit to form a slurry and poured into blending tank.

2. Asphalt is crushed in a pulveriser into sizes of 1″-2″. It is then weighed and fed into the heating tank. This is heated to 140 degrees C.-150 degrees C. In the molten state this is poured into the blending tank and blended for 10 minutes.

3. Remaining toluene and white spirit solvents are pumped into the blending tank at this stage.

4. The rubber which was pre-weighed and dissolved by stirring with 50% of the toluene is then added at this stage. Blend for 20 minutes, reaction bonding must occur.

5. Zinc chromate pigment and titanium dioxide pigment are then added at this stage.

6. Finally the methylated spirit is poured into the blending tank to give a uniform consistency.

7. The product is then fed through the vibratory screen of sizes 25 mesh and 80 mesh for a finished product.

8. The blending tank is jacketed to allow a cooling solution to flow through during the blending process. Temperature of finished product: 50° C.-60° C.

Additional information, in the form of a data sheet, regarding characteristics and usage of this exemplary zinc chromate primer grey product are set forth below.

This product provides a two-in-one rubberized natural asphalt coating. It has all the properties of the zinc chromate primer black product described above, but is pigmented to a grey finish.

| | |
|---|---|
| COMPONENT | One pack |
| SURFACE PREPARATION | Surfaces should be free from grease, |
| | oil or rust. Remove rust using a |
| | wire brush or a power tool. See |
| | zinc chromate primer black product above. |
| COVERAGE | 6 sq. meter/liter |
| DRY FILM THICKNESS | 80-100 microns |
| SOLIDS CONTENT | 60-70% |
| SPECIFIC GRAVITY | 1.14 |
| DRYING TIME | 30-45 minutes |
| FLASH POINT | 37° C. |
| APPLICATION | Brush, spray or roll-on |
| COLOR | Bone grey |
| AREAS OF USE | On metal surfaces |
| THINNING & CLEAN-UP | Surecoat #AP4 Reducer |
| RECOMMENDED USES | On all metal surfaces, where priming |
| | is necessary. No overcoat required. |

Road Marking Product Example

The following is an example of a road marking product made in accordance with one embodiment of the instant invention. A variety of improved road marking products can be made using the following elements in the approximate ranges (percent by weight) set forth below:

| | |
|---|---|
| TLA | 1% to 80% |
| Polymers/Co-polymers | 1% to 95% |
| Carriers | 1% to 80% |
| Clays | 1% to 80% |

Different polymers/co-polymers are used such that different Tg's (i.e. glass transition temperatures) are obtained. This enables the road-marking paint to remain flexible at extremely low temperatures. The complete TLA can be used, so that no part of the TLA has to be removed. The process involves the reaction of TLA with a Polymer/Elastomer mixture, a reaction between TLA and silica, and a reaction between TLA and clays. If desired, any color can be created through the addition of Pigments. The resulting Coating can be epoxidised or non-epoxidised.

All of the coating products described above are environmentally friendly and can be advantageously used in place of many prior art coatings. The coatings can be used in, for example, the marine environment, potable water systems, sewer systems, heavy industry, construction industry, environmentally oppressive conditions, and many other applications.

The coatings made in accordance with the instant invention are, among other things: resistant to petroleum distillates; aromatic solvents; salt water immersion; acids; alkalis; sour crudes and lubricating oils; and sea blast. The coatings are also unaffected by, for example, fresh water; deionized/distilled water systems; bromides; chlorides; and sulphates;

In addition, the coatings have enhanced durability, flexibility; resistance to abrasion; resistance to an applied force; resistance to aromatic solvents; and aesthetic properties. The coatings may also be used in low temperature environments without degradation.

It is noted that, in accordance with the instant invention, in any of the exemplary processes described above, a Banbury mixer or high shear internal mixer can be used to ensure that reaction bonding occurs between, for example, the TLA, raw material and clay.

While the preferred forms and embodiments of the invention have been illustrated and described, it will be apparent to those of ordinary skill in the art that various changes and modifications may be made without deviating from the inventive concepts and true spirit of the invention as set forth above, and it is intended by the appended claims to cover all such changes and modification which come within the full scope and true spirit of the invention.

What is claimed is:

1. A coating, comprising Trinidad Lake Asphalt and at least one other raw material.

2. A coating as defined in claim 1, wherein said one other raw material includes a solid carrier.

3. A coating as defined in claim 1, wherein said at least one other raw material includes a liquid carrier.

4. A coating as defined in claim 1, wherein said at least one other raw material includes a gaseous carrier.

5. A coating as defined in claim 1, wherein said at least one other raw material includes a solid carrier and a liquid carrier.

6. A coating as defined in claim 1, wherein said at least one other raw material is selected from the group consisting of: polymers/co-polymers, carrier, clay, pigment, carbonaceous material and resins.

7. A coating as defined in claim 1, wherein said coating is an epoxy.

8. A coating as defined in claim 7, wherein said epoxy includes, in combination with said Trinidad Lake Asphalt, polymers/co-polymers, carrier, clay and resin.

9. A coating as defined in claim 1, wherein said coating is a sealant.

10. A coating as defined in claim 9, wherein said sealant includes, in combination with said Trinidad Lake Asphalt, polymers/co-polymers, carrier and clay.

11. A coating as defined in claim 1, wherein said coating is a roofing compound.

12. A coating as defined in claim 11, wherein said roofing compound includes, in combination with said Trinidad Lake Asphalt, polymers/co-polymers, carrier, clay and pigment.

13. A coating as defined in claim 1, wherein said coating is an underbody coating or sound deadener.

14. A coating as defined in claim 13, wherein said underbody coating or sound deadener includes, in combination with said Trinidad Lake Asphalt, polymers/co-polymers, carrier and clay.

15. A coating as defined in claim 1, wherein said coating is a water tank paint.

16. A coating as defined in claim 15, wherein said water tank paint includes, in combination with said Trinidad Lake Asphalt, polymers/co-polymers, carrier and clay.

17. A coating as defined in claim 1, wherein said coating is a chassis black coating.

18. A coating as defined in claim 17, wherein said chassis black coating includes, in combination with said Trinidad Lake Asphalt, polymers/co-polymers, carrier and clay.

19. A coating as defined in claim 1, wherein said coating is a zinc chromate primer.

20. A coating as defined in claim 19, wherein said zinc chromate primer includes, in combination with said Trinidad Lake Asphalt, polymers/co-polymers, carrier, clay and pigment.

21. A coating as defined in claim 1, wherein said coating is an electrical resistance coating.

22. A coating as defined in claim 21, wherein said electrical resistance coating includes, in combination with said Trinidad Lake Asphalt, polymers/co-polymers, carrier, clay and carbonaceous material

23. A coating as defined in claim 1, wherein said coating is a membrane.

24. A coating as defined in claim 23, wherein said membrane has a dry film thickness of at least 2 mil and includes, in combination with said Trinidad Lake Asphalt, polymers/co-polymers, carrier, clay, carbonaceous material and pigment.
